(19) United States
(12) Patent Application Publication
(10) Pub. No.: US 2025/0029028 A1
(43) Pub. Date: Jan. 23, 2025

(54) TASK MANAGEMENT SYSTEM

(71) Applicant: Gary Spirer, Austin, TX (US)

(72) Inventor: Gary Spirer, Austin, TX (US)

(21) Appl. No.: 18/777,350

(22) Filed: Jul. 18, 2024

Related U.S. Application Data
(60) Provisional application No. 63/514,338, filed on Jul. 18, 2023.

(51) Int. Cl. G06Q 10/0631; G06F 40/205; G06V 10/70

(52) U.S. Cl. CPC G06Q 10/063112; G06F 40/205; G06V 10/70

(57) ABSTRACT

Apparatuses, methods, systems, and program products are disclosed for a task management system. An apparatus is configured to parse a file comprising compliance information to identify at least one compliance task, create at least one compliance object based on compliance information for the at least one compliance task, and assign the at least one compliance object to at least one user configured to complete the at least one compliance task.

### CROSS-REFERENCE TO RELATED APPLICATIONS

This application claims the benefit of U.S. Provisional Patent Application No. 63/514,338 entitled “TASK MANAGEMENT SYSTEM” and filed on Jul. 18, 2024, for Gary Spirer, which is incorporated herein by reference.

### FIELD

This invention relates to task management and more particularly relates to task management for compliance tasks.

### BACKGROUND

Compliance management is crucial for certain organizations that rely on accreditation to continue to operate. However, keeping track of compliance tasks and when the compliance tasks need to be completed can be an overwhelming and painstaking task.

### SUMMARY

Apparatuses, methods, systems, and program products are disclosed for a task management system. In one embodiment, an apparatus is configured to parse a file comprising compliance information to identify at least one compliance task, create at least one compliance object based on compliance information for the at least one compliance task, and assign the at least one compliance object to at least one user configured to complete the at least one compliance task.

A method, in one embodiment, includes parsing a file comprising compliance information to identify at least one compliance task, creating at least one compliance object based on compliance information for the at least one compliance task, and assigning the at least one compliance object to at least one user configured to complete the at least one compliance task.

In one embodiment, a program product includes a non-transitory computer readable storage medium that stores code executable by a processor for parsing a file comprising compliance information to identify at least one compliance task, creating at least one compliance object based on compliance information for the at least one compliance task, and assigning the at least one compliance object to at least one user configured to complete the at least one compliance task.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for task management;

FIG. 2 is a schematic block diagram illustrating one embodiment of an apparatus for task management;

FIG. 3 is a schematic block diagram illustrating one embodiment of another apparatus for task management;

FIG. 4 is a schematic flow-chart diagram illustrating one embodiment of a method for task management;

FIG. 5 is a schematic flow-chart diagram illustrating one embodiment of another method for task management; and

FIG. 6 is a schematic flow-chart diagram illustrating one embodiment of another method for task management.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages ay be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and D illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

The schematic flowchart diagrams and/or schematic block diagrams in the FIGS. illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Apparatuses, methods, systems, and program products are disclosed for a task management system. In one embodiment, an apparatus is configured to parse a file comprising compliance information to identify at least one compliance task, create at least one compliance object based on compliance information for the at least one compliance task, and assign the at least one compliance object to at least one user configured to complete the at least one compliance task.

In one embodiment, the at least one compliance task is associated with a location. In one embodiment, the location comprises at least one of a building, a floor, or a room. In one embodiment, the at least one compliance task is associated with an asset at the location.

In one embodiment, the at least one processor is configured to cause the apparatus to generate a unique code for the asset. In one embodiment, the unique code comprises a scannable code that comprises a link to the at least one compliance object comprising information for the at least one compliance task associated with the asset. In one embodiment, the at least one processor is configured to cause the apparatus to process an image of the location using an artificial intelligence engine to identify at least one asset at the location and provide compliance information for the at least one asset from the at least one compliance object associated with the at least one asset.

In one embodiment, the at least one processor is configured to cause the apparatus to generate a compliance schedule for the at least one compliance task. In one embodiment, the at least one processor is configured to cause the apparatus to notify the user assigned to complete the at least one compliance task at least once prior to a completion deadline for the at least one compliance task based on the compliance schedule.

In one embodiment, the at least one processor is configured to cause the apparatus to generate a workflow for completing the at least one compliance task based on the compliance schedule. In one embodiment, the at least one processor is configured to cause the apparatus to optimize the workflow based on dependencies between the at least one compliance task. In one D embodiment, the at least one processor is configured to cause the apparatus to provide the workflow to an artificial intelligence engine for optimization.

In one embodiment, the at least one processor is configured to cause the apparatus to present the compliance information for the at least one compliance task for the at least one compliance object on a graphical interface. In one embodiment, the at least one processor is configured to cause the apparatus to visually highlight the at least one compliance task based on state of the at least one compliance task. In one embodiment, the at least one processor is configured to cause the apparatus to provide a generative artificial intelligence interface for receiving prompts related to the at least one compliance task.

A method, in one embodiment, includes parsing a file comprising compliance information to identify at least one compliance task, creating at least one compliance object based on compliance information for the at least one compliance task, and assigning the at least one compliance object to at least one user configured to complete the at least one compliance task.

In one embodiment, the at least one compliance task is associated with a location. In one embodiment, the location comprises at least one of a building, a floor, or a room. In one embodiment, the at least one compliance task is associated with an asset at the location.

In one embodiment, the method is configured to generate a unique code for the asset. In one embodiment, the unique code comprises a scannable code that comprises a link to the at least one compliance object comprising information for the at least one compliance task associated with the asset. In one embodiment, the method is configured to process an image of the location using an artificial intelligence engine to identify at least one asset at the location and D provide compliance information for the at least one asset from the at least one compliance object associated with the at least one asset.

In one embodiment, the method is configured to generate a compliance schedule for the at least one compliance task. In one embodiment, the method is configured to notify the user assigned to complete the at least one compliance task at least once prior to a completion deadline for the at least one compliance task based on the compliance schedule.

In one embodiment, the method is configured to generate a workflow for completing the at least one compliance task based on the compliance schedule. In one embodiment, the method is configured to optimize the workflow based on dependencies between the at least one compliance task. In one embodiment, the method is configured to provide the workflow to an artificial intelligence engine for optimization.

In one embodiment, the method is configured to present the compliance information for the at least one compliance task for the at least one compliance object on a graphical interface. In one embodiment, the method is configured to visually highlight the at least one compliance task based on state of the at least one compliance task. In one embodiment, the method is configured to provide a generative artificial intelligence interface for receiving prompts related to the at least one compliance task.

In one embodiment, a program product includes a non-transitory computer readable storage medium that stores code executable by a processor for parsing a file comprising compliance information to identify at least one compliance task, creating at least one compliance object based on compliance information for the at least one compliance task, and assigning the at least one compliance object to at least one user configured to complete the at least one compliance task.

In one embodiment, the at least one compliance task is associated with a location. In one embodiment, the location comprises at least one of a building, a floor, or a room. In one embodiment, the at least one compliance task is associated with an asset at the location.

In one embodiment, the code is executable by a processor to generate a unique code for the asset. In one embodiment, the unique code comprises a scannable code that comprises a link to the at least one compliance object comprising information for the at least one compliance task associated with the asset. In one embodiment, the code is executable by a processor to process an image of the location using an artificial intelligence engine to identify at least one asset at the location and provide compliance information for the at least one asset from the at least one compliance object associated with the at least one asset.

In one embodiment, the code is executable by a processor to generate a compliance schedule for the at least one compliance task. In one embodiment, the code is executable by a processor notify the user assigned to complete the at least one compliance task at least once prior to a completion deadline for the at least one compliance task based on the compliance schedule.

In one embodiment, the code is executable by a processor to generate a workflow for completing the at least one compliance task based on the compliance schedule. In one embodiment, the code is executable by a processor to optimize the workflow based on dependencies between the at least one compliance task. In one embodiment, the code is executable by a processor to provide the workflow to an artificial intelligence engine for optimization.

In one embodiment, the code is executable by a processor to present the compliance information for the at least one compliance task for the at least one compliance object on a graphical interface. In one embodiment, the code is executable by a processor to visually highlight the at least one compliance task based on state of the at least one compliance task. In one embodiment, the code is executable by a processor to provide a generative artificial intelligence interface for receiving prompts related to the at least one compliance task.

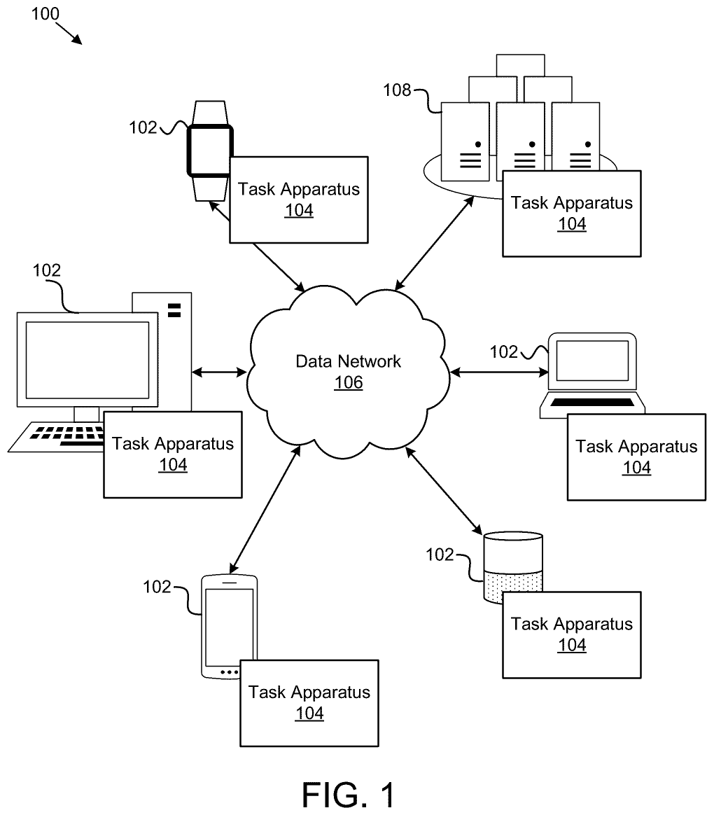

FIG. 1 is a schematic block diagram illustrating one embodiment of a task management system 100. In one embodiment, the system 100 includes one or more information handling devices 102, one or more task apparatuses 104, one or more data networks 106, and one or more servers 108. In certain embodiments, even though a specific number of information handling devices 102, task apparatuses 104, data networks 106, and servers 108 are depicted in FIG. 1, one of skill in the art will recognize, in light of this disclosure, that any number of information handling devices 102, task apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like. The information handling devices 102 may include executable code, functions, instructions, operating systems, and/or the like for task management.

In one embodiment, the task apparatus 104 is configured to organize, assign, schedule, monitor, and/or the like tasks associated with compliance. As used herein, compliance refers to adherence to a predefined set of standards, regulations, rules, and/or other requirements as established by a board or organization (e.g., an accreditation organization, a government agency, or the like).

The task apparatus 104, in one embodiment, is part of a multi-purpose system, e.g., task management system 100 that organizes, manages, and connects various touch points across an entire organization and its channels offline and online. In certain embodiments, the task apparatus 104 automates, integrates, connects numerous engagements, interactions, communications, stories, conversations, tasks, etc., and connects with numerous other systems to fulfill the needs of the organization, company, business, etc. on any electronic device to increase efficiency, effectiveness, security, compliance, safety, presentation, etc., among all stakeholders in an ecosystem/network etc.

As described herein, the task management system 100 may be embodied as a remote, data-driven hospital safety and compliance system whose policies, activities, reports, and timelines are governed by the joint commission—and may be used to integrate with other governing bodies and agencies including but not limited to the occupational safety and health administration (“OSHA”).

In certain embodiments, the task apparatus 104 is configured to parse a file comprising compliance information to identify at least one compliance task, create at least one compliance object based on compliance information for the at least one compliance task, and assign the at least one compliance object to at least one user configured to complete the at least one compliance task. In certain embodiments, the task apparatus 104 utilizes artificial intelligence in various ways, processes, methods, or the like to optimize, forecast, predict, schedule, and/or the like the compliance tasks.

In certain embodiments, the task apparatus 104 is embodied as a mobile program, application, software-as-a service, or the like that can be a web application, for instance, and is downloadable. In such an embodiment, the mobile application may be optimized for integration with third-party systems, e.g., location or mapping systems, human resource systems, and/or the like.

In one embodiment, the task apparatus 104 provides a solution over conventional compliance systems in that it has universal applicability for different organizations or divisions within an organization that are accredited based on different compliance standards. The task apparatus 104 also provides a risk management solution to reduce or avoid compliance issues. Furthermore, the task apparatus 104 improves the security of the compliance system by enforcing permissions, access control lists, time-stamping access and changes, and/or the like. Moreover, the task apparatus 104 integrates with various third-party applications such as cloud storage providers, e.g., Dropbox®, advertisers, affiliates, artificial intelligence engines, predictive analytics engines, and/or the like. The task apparatus 104 also provides and sends compliance reminders automatically, generates and maintains inspection schedules, and/or the like. The foregoing improvements remove many of manual steps previously done on paper and reduces errors in compliance maintenance, which can be crucial to avoid missing compliance deadlines, creating errors in the compliance paperwork, and/or the like.

In various embodiments, the task apparatus 104 may be embodied as a hardware appliance that can be installed or deployed on an information handling device 102, on a server 108, or elsewhere on the data network 106. In certain embodiments, the task apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the task apparatus 104 may include a power interface, a wired and/or wireless network interface, a graphical interface that attaches to a display, and/or a semiconductor integrated circuit device as described below, configured to perform the functions described herein with regard to the task apparatus 104.

The task apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the task apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the task apparatus 104.

The semiconductor integrated circuit device or other hardware appliance of the task apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the task apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. The one or more servers 108 may store data associated with an information handling device 102.

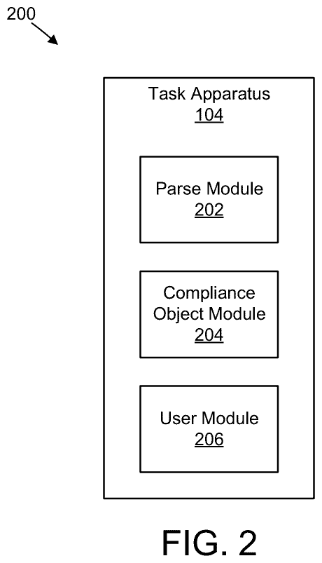

FIG. 2 illustrates one embodiment of an apparatus 200 for a task management system. The apparatus 200, in certain embodiments, includes an instance of a task apparatus 104. The task apparatus 104, in one embodiment, includes one or more of a parse module 202, a compliance object module 204, and a user module 206, which are described in more detail below.

In one embodiment, the parse module 202 is configured to parse, process, analyze, or the like a file comprising compliance information to identify at least one compliance task. The file may be a digital version of a compliance manual, policy, regulation, rule, or the like, in a certain format such as PDF, word processor, spreadsheet, and/or other custom or specialized format. A compliance file, for example, may be established by an accreditation board or organization, by a government or other regulatory agency, and/or the like. For example, hospitals may be required to comply with policies and regulations established by The Joint Commission to earn and maintain accreditation as a healthcare provider. The parse module 202 may access the file from a local repository, a website, a file sharing site (e.g., Dropbox®), and/or the like.

In one embodiment, the parse module 202 periodically checks for updates to the file, checks for new versions of the file, receives a notification that a new version of the file is available, checks change logs for changes to the file, and/or the like such that previously-parsed compliance information can be updated, modified, removed, added to, or the like.

A compliance task, as used herein, refers to a task, job, duty, workflow, or the like that needs to be performed and reported to comply with the compliance requirements of the compliance policy. For instance, in a healthcare scenario, a compliance task may be to check or inspect the status of various assets or equipment (e.g., whether the equipment is in good working order, needs repairs, or is obsolete or broken), determine whether certain processes are being implemented according to the regulated guidelines (e.g., that the steps are being performed in the correct or suggested order), check the status of doctors, nurses, and other hospital personnel (e.g., ensuring licenses, certifications, etc. are valid and up to date), perform maintenance, test equipment, and/or the like. Thus, a compliance task may be associated with a piece of equipment, a process, a person, a location, and/or the like.

In one embodiment, the parse module 202 parses the file, e.g., a compliance manual, using natural language processing, regular expressions, and/or other text processing methods, to identify different compliance tasks and requirements for completing the compliance tasks. For instance, the parse module 202 may identify that a compliance task requires the user to enter an asset identifier, an expiration date, a supervisor name, and a date that the last compliance task was completed.

In certain embodiments, in addition to the compliance requirements from the compliance policy/manual, the parse module 202 may receive information for compliance tasks that an administrator or other user has created, e.g., custom or special compliance tasks that may not be listed in the compliance policy/manual.

In one embodiment, the compliance object module 204 is configured to create at least one compliance object based on compliance information for the at least one compliance task. As used herein, a compliance object may be a data structure, file, metadata, or the like that includes information for the compliance task such as the task type, the completion date, previous dates when the compliance task was completed, who is assigned to the compliance task, and/or the like.

As described below, the compliance object may contain all the necessary information needed to complete a compliance task, based on the information that the parse module 202 captures, and used to generate task workflows, display compliance task requirements to a user, and/or the like.

In one embodiment, the user module 206 is configured to assign the at least one compliance object to at least one user configured to complete the at least one compliance task. In certain embodiments, the user module 206 is configured to assign one or more users to a compliance object for a compliance task based on various roles, titles, a hierarchy, an organizational chart, or the like of the users associated with an organization. For example, the user module 206 may assign certain hospital staff members, maintenance crew, or the like to different compliance objects for compliance tasks based on the users' experiences, education, and/or the like, or in response to user input, e.g., from a hospital administrator.

The user module 206 may assign third-party vendors such as contract workers, technicians, equipment repair and maintenance personnel, or the like to compliance tasks. For example, if a hospital hires a third-party service to provide, maintain, and repair fire extinguishers, these users may be added to the list of approved third-party vendors who can perform compliance tasks for the fire extinguishers because they have the expertise and experience to verify that the fire extinguishers comply with the compliance requirements of the compliance task. The user module 206, therefore, defines permissions, access control lists, and/or the like for the compliance tasks and the associated compliance templates.

In further embodiments, the user module 206 may utilize a biometric compliance authentication system to verify and authenticate completion of the compliance task, the user that completed a compliance task, and/or the like. For instance, an user may provide biometric information, e.g., a fingerprint, voice command, or the like, to verify the user's identity and that the user is authorized to perform the compliance task. Further, upon completion, the user may provide biometric information to confirm completion of the compliance task.

In one embodiment, a user module 206 uses an artificial intelligence (AI) engine to assign users to compliance objects for a compliance task. The AI engine may be any type of AI engine that performs various machine learning operations including supervised machine learning, unsupervised machine learning, reinforcement learning, and/or the like. In such an embodiment, the AI engine may be trained (see below) on compliance data, user data, workflow data, scheduling data, and/or the like to determine the best or optimal users to assign to a compliance task.

In one embodiment, the user module 206 generates custom roles for users, e.g., technicians, maintenance, administrators, project leaders, and/or the like, which can tie into the human resources system for the organization. As used herein, the roles may define the abilities, activities, permissions, and/or the like that are assigned to a user. The roles may define the types of activities the user can perform, when the user can work (e.g., the users' shifts), where the user can work (e.g., the permissions/authorizations that the user has), and/or the like.

In such an embodiment, based on the users' roles, the user module 206 assigns compliance tasks, resources, tools, forms (e.g., compliance templates), and/or the like that need to be performed for compliance/accreditation with the standards associated with the industry that the organization is associated with, e.g., healthcare for hospitals.

For example, the user module 206 determines, based on a digitized version of a compliance manual, which compliance tasks are required to maintain or gain accreditation or compliance for an industry such as health care. The user module 206 may determine which users to assign to the compliance tasks, based on the users' roles and/or locations, and/or may automatically assign users to compliance tasks, and provide the necessary tools, resources, and/or the like for performing the compliance task, e.g., compliance forms.

In this manner, the task apparatus 104 can convert or transform a rule, regulation, policy, or the like from a file, such as a compliance manual, a policy, a policy and procedures manual, a handbook, and/or the like, to create task objects such as a compliance object that includes the information required to complete the task as outlined in the manual, and assign the task object to users who are a best fit for completing the task, without requiring much, if any, feedback, intervention, or input from a user.

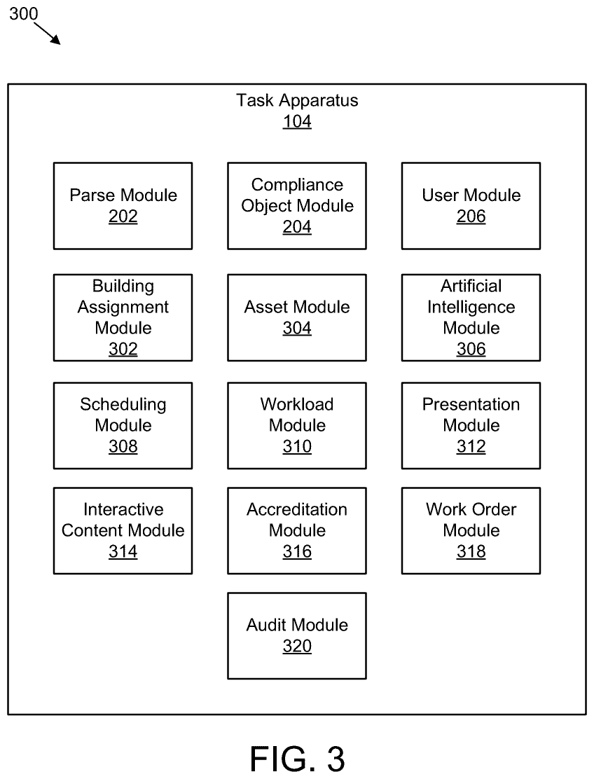

FIG. 3 illustrates one embodiment of an apparatus 300 for a task management system. The apparatus 300, in certain embodiments, includes an instance of a task apparatus 104. The task apparatus 104, in one embodiment, includes one or more of a parse module 202, a compliance object module 204, and a user module 206, which may be substantially similar to the parse module 202, the compliance object module 204, and the user module 206 described above with reference to FIG. 2. Furthermore, in certain embodiments, the task module 104 includes one or more of a building assignment module 302, an asset module 304, an artificial intelligence module 306, a scheduling module 308, a workload module 310, a presentation module 312, an interactive content module 314, an accreditation module 316, a work order module 318, and an audit module 320, which are described in more detail below.

In one embodiment, the building assignment module 302 is configured to assign or associate the compliance task with a location such as a building, wing, floor, level, center, room, or the like. For example, the compliance task may be assigned to a hospital building where an emergency room is located, to the floor of the hospital where the trauma center is located, and/or the like. In such an embodiment, the organization, e.g., the hospital, may maintain a layout, map, or the like of locations of the building and the sub-locations of the building including the rooms, floors, levels, stories, and/or the like, which the building assignment module 302 can use to associate a compliance object or task to the location where the compliance task is to be completed. In one embodiment, the building assignment module 302 associates the compliance task to the location in the compliance object or notifies the compliance object module 204 of the location for the compliance task.

In one embodiment, the asset module 304 is configured to associate or assign an asset to/with a compliance task that is associated with the asset. As used herein, an asset may refer to a physical object or item at a location that is the subject of a compliance task. Examples may include fire extinguishers, smoke alarms, door latches, locks, emergency lights, and/or the like. In one embodiment, the asset module 304 may maintain a list, table, database, or the like of assets at a location, e.g., all the assets for a building, the assets for a floor or level of the building, the assets for a room in the building, and/or the like.

In one embodiment, the parse module 202 identifies an asset that is the subject of a compliance task when the compliance manual is analyzed to identify the compliance task. In such an embodiment, the parse module 202 may notify the asset module 304 of the asset, may flag the asset in the compliance object, may lookup the asset (or a best match asset) in a listing or table of assets, and/or the like.

In one embodiment, the asset module 304 generates a unique code for the asset, such as a unique asset identifier. In one embodiment, the asset module 304 generates a scannable code for the asset based on the unique code. For example, the asset may be identified using an identification tag (e.g., an RFID tag, a barcode, a QR code, a wireless signal (e.g., a Bluetooth® signal), an IP or MAC address, and/or the like) that is located on the asset or at a location where the asset is located (e.g., on a door, wall, or the like). In such an embodiment, a user assigned to a compliance task may scan the code, e.g., a QR code, using a user device, e.g., a smart phone, which includes a link to the compliance information for the compliance task and which may be presented in a graphical interface.

In one embodiment, the asset module 304 may associate a location where the asset is location with the asset. In such an embodiment, a location service, e.g., a mapping service, may be used to determine the location of the asset within a building, on a floor, etc., and display the asset's location on a map that is included in the compliance object as part of the compliance task.

In one embodiment, an artificial intelligence module 306 may use or provide an artificial intelligence engine, machine learning models, and/or the like to process, provide, query, forecast, estimate, and/or the like information related to a compliance task. In one embodiment, the artificial intelligence module 306 may be a generative artificial intelligence engine that is trained or configured to receive and process prompts, queries, questions, or the like and generate a response. In this instance, the generative AI may be trained on compliance data, e.g., data from compliance manuals, previous tasks, asset information, building information, user information, and/or the like.

For example, a prompt may include “show the assets in the building on map,” “how many tasks is Julie assigned to,” who is the best user to perform this compliance task, “how many tasks are out of compliance,” and/or the like. In one embodiment, the artificial intelligence module 306 receives an image of a location and processes the image to identify the assets and other compliance information associated with the items in the image. For instance, a user may enter a room, capture a picture of the room with a smart phone, and then upload or submit the image to the task apparatus. The artificial intelligence module 306 may process the image to identify different assets in the image for the room, an identifier for the room, and/or the like and provide or display links to compliance information for the assets and/or room such as links to the compliance task information for each asset, compliance task information for the room, and/or the like.

In one embodiment, the artificial intelligence module 306 receives, monitors, checks, and/or the like for updates to manuals, policies, procedures, rules, regulations, and/or the like. For instance, the artificial intelligence module 306 may, via an application programming interface (API), or some other interface, receive updates/changes to a compliance manual. Based on the updates, the artificial intelligence module 206 may dynamically trigger, instruct, signal, or command the parse module 202 to analyze the updates to generate new compliance objects for new compliance tasks that result from the updates and/or to update existing compliance objects to reflect changes to existing compliance tasks.

The artificial intelligence module 306 may monitor resources to receive industry trends, company/domain-specific data, and/or the like, which can be used to further train the artificial intelligence engine/model to be up-to-date on compliance updates. For instance, the artificial intelligence module 306 may monitor websites, blogs, administrative sources, company-specific data repositories, blogs, and/or the like to determine updates in the compliance space.

In one embodiment, the artificial intelligence module 306 may monitor, sense, check, or the like environmental sensors, e.g., smoke alarms, smart thermostats, light sensors, motion sensors, cameras, and/or other Internet of Things devices for sensor data, information, or the like related to compliance factors. For example, a smart smoke alarm may indicate that its battery will be out of power within a week.

In one embodiment, the artificial intelligence module 306 predicts potential compliance issues before they occur. For instance, the artificial intelligence module 306 may predict or forecast that a fire extinguisher will expire or not be effective before a marked expiration date, e.g., based on third-party data, company data, manufacture data, and/or the like.

In one embodiment, the scheduling module 308 is configured to determine deadlines for completing each of the compliance tasks, as defined by the compliance policy/manual. For example, the compliance manual may require that fire alarms within a hospital be tested every three months. Based on the deadlines for each compliance task, the scheduling module 308 generates a compliance schedule for each compliance task and associates the compliance schedule with each compliance object representing each compliance task.

The scheduling module 308 may be graphically displayed as a timeline, a calendar, and/or the like that includes reminders and deadlines for the compliance tasks that need to be completed, or that have already been completed. Furthermore, the scheduling module 308 may include a color scheme for different deadlines/states for the compliance tasks. For example, if a compliance task is complete it may show up as green, if a compliance task is late (past the deadline, out of compliance) it may show up as red, reminders may show up as yellow, orange, or the like based on the time between the reminder and the scheduled deadline date, and/or the like. In this manner, a user can quickly see the complete schedule for completion of a compliance task.

Furthermore, the scheduling module 308 may generate and send one or more reminders, push notifications, alerts, emails, text messages, chat messages, and/or the like for completing the compliance tasks. The scheduling module 308 may set different points in time for sending reminders, such as one week before the deadline, two weeks before the deadline, one month before the deadline, three months before the deadline, semi-annually, annually, and/or the like, and/or any combination of the foregoing.

For example, continuing with the fire alarm example, if the scheduling module 308 determines that the fire alarms need to be tested every three months, the scheduling module 308 may send reminders/notifications to users who are assigned to the compliance task two months before the deadline, one month before the deadline, two weeks before the deadline, a week before the deadline, three days before the deadline, and the day before the deadline, and/or the like. In this manner, the scheduling module 308 can send constant reminders about completing compliance tasks at various points in time leading up to the compliance deadline. In certain embodiments, the scheduling module 308 may utilize the artificial intelligence module 306 to generate and/or optimize the compliance schedule for a compliance task, for a series of compliance tasks, and/or the like.

In one embodiment, the workload module 310 is configured to generate a workflow for completing the at least one compliance task based on the compliance schedule. As used herein, a workflow may refer to a series or order for completing a plurality of compliance tasks. In some embodiments, the workload module 310 determines whether there is a sequential order or dependency between multiple compliance tasks and determines an optimized order that the compliance tasks should be completed, when they need to be completed, and/or the like, and assigns the compliance tasks in the determined order. In certain embodiments, the workload module 310 may use the artificial intelligence module 306 to determine the optimized order of completing tasks, assigning tasks, and/or the like. For example, the workload module 310 may provide a prompt to a generative AI such as “determine an optimized order for completing these tasks . . . ”, and/or the like.

In one embodiment, the presentation module 312 is configured to electronically or digitally present information for a compliance task, e.g., from the compliance object, and may receive information related to the compliance task during and/or after completion of the compliance check, e.g., after inspection, testing, maintenance, and/or the like. The presentation module 312, for instance, may present the compliance task information in a web browser, in a mobile application, and/or the like, on a display of a user's device such as a smart phone, a tablet device, a smart watch, an head-mounted display unit, a virtual or augmented reality device, and/or the like.

In one embodiment, the presentation module 312 tracks various characteristics/analytics/metrics of the user's interaction with the compliance task information. For instance, the presentation module 312 may track how long a compliance task view is open, how long a user views an interactive content element, which interactive content elements the user interacts with, how long it takes a certain user to complete a compliance task, and/or the like. These metrics may be used to determine how efficient certain users are, how difficult certain compliance tasks are, which vendors are the most efficient/cost effective, where more training needs to be implemented and for which users, and/or the like.

In this manner, the user performing the compliance check will have access to the compliance task information that are available to the user as the user performs compliance tasks/checks within their organization, e.g., within a hospital. Initially, the user may need to provide credentials (e.g., username/password, biometric information, etc.) to verify the user's identity to access the compliance template. The user can then perform the compliance task on site, using their electronic device, and enter compliance information into the form fields, take images of the compliance check to verify the user's responses (e.g., images of equipment), live stream the compliance check (e.g., for verification, feedback, training, or the like), and/or the like.

In one embodiment, the presentation module 312 presents an interface, e.g., a dashboard, for prioritizing tasks, assigning tasks, setting deadlines, determining equipment that is necessary for the task, and/or the like. The presentation module 312 may present a dashboard interface for the entire organization, for a department, for a user, and/or the like.

In one embodiment, the presentation module 312 presents widgets within the interface. As used herein, the widgets are graphical elements that are used to display complex information in a way that is easy to understand and that updates in real time. Widgets can be created from scratch or from templates. Widgets can group or organize anything from the list of all facilities by location or compliance jobs by location or by any attribute(s) that are monitored. Each widget can then have links to different views or different views can be widgets themselves, which then can link to other multiple views, such as assets, workload, workflow, timeline, and/or the like.

In one embodiment, the widgets are customizable by users, administrators, and/or other users. The widgets may present information regarding the status of different compliance tasks (e.g., whether the status is active, finished, in progress, halted, late, out of compliance, and/or the like), how many tasks or jobs were done, when the tasks/jobs were done, who performed the tasks, evidence of the task being performed (e.g., pictures, videos, etc.), and/or the like. In some embodiments, the dashboard and/or widgets display compliance analytics, compliance statistics, compliance metrics, and/or the like for an organization, for a department, for a group, for a user, and/or the like.

In one embodiment, the presentation module 312 is configured to provide an augmented reality environment, a virtual reality environment, a mixed reality environment, and/or the like. For instance, a user with a heads-up display unit may enter a room and the presentation module 312 may highlight or visually augment various assets in the room that are associated with a compliance task, e.g., fire extinguishers, smoke alarms, or the like (e.g., as detected and identified by the artificial intelligence module 306).

The interactive content module 314, in one embodiment, is configured to include one or more interactive multimedia elements in the compliance object for the compliance task. The interactive multimedia elements may include interactive videos, images, slideshows, quizzes, surveys, polls, hotspots, and/or other interactive content. An interactive video, for example, may include video branching where a segment of the video is played based on the user's response to a question on the video (as described in more detail in U.S. Pat. No. 9,535,577, which is incorporated by reference herein in its entirety).

In certain embodiments, the interactive content module 314 accesses the interactive content from a local repository, from a remote server, from a content hosting site (e.g., YouTube®), from a social media platform (e.g., Facebook®), and/or the like. The interactive content may be tagged with keywords that make it searchable so that the interactive content module 314 can locate interactive content that is relevant to the compliance task. For example, if the compliance task is related to inspection or maintenance of x-ray equipment, the interactive content module 314 may filter the available interactive content based on the keyword or tag “x-ray” to find interactive content that is related to the compliance task. The interactive content module 314 may further refine or narrow the search using additional, secondary keywords (e.g., “MRI x-rays”).

The interactive content module 314, therefore, may integrate, overlay, inlay, or otherwise place interactive content that is associated with the compliance task within the compliance template. For instance, the interactive content element may include instructional videos on how to perform a compliance check for the compliance task, a live-streaming video to/from an administrator or third-party vendor that walks a user through performing a compliance task in real time, a webinar, a training video, a slideshow with steps for performing the compliance check (which may also include video/images), and/or the like.

In one embodiment, the accreditation module 316 is configured to send the results of the compliance task, e.g., the information that was entered into the compliance template to an accreditation organization, and/or batch a plurality of completed compliance templates to be sent to the accreditation organization as evidence that the organization is in compliance with the policies, rules, regulations, or the like that the accreditation organization established. The accreditation module 316 may have a direct connection (online) to the accreditation organization so that when a compliance template is complete, the accreditation module 316 sends the template directly to the accreditation organization. In certain embodiments, an administrator, manager, supervisor, or the like may have to sign off on the completed compliance template prior to the accreditation module 308 sending it to the accreditation organization.

In one embodiment, the work order module 318 is configured to generate one or more work orders, requests for proposals, or the like for third-party vendors based on the compliance task and the schedule for completing the compliance task. As used herein, a work order may be a request to complete a task or job as it relates to the compliance task and may be generated for maintenance services, inspection services, equipment management services, and/or the like. For instance, if the elevators in a hospital need to be serviced, the work order module 318 may generate and send a work order request to an elevator service company that the hospital has approved as a third-party vendor for the hospital. The work order module 318 may check the deadline for completing the compliance check and send the work order some time prior to the deadline so that the third-party vendor has time to schedule and prepare to work on the compliance task.

In one embodiment, the audit module 320 is configured to maintain a user login history, a history of users that entered information into the compliance template, timestamps for each access and data entry into the compliance templates, and/or the like. In this manner, the audit module 320 can provide a snapshot or history of which users accessed the templates, when they were last modified, when new templates were created, which users entered data into the templates, when templates were completed and/or submitted for review/accreditation, and/or the like. In one embodiment, the audit module 320 may track compliance activities, histories, or the like using a blockchain system. As used herein, blockchain may refer to is a distributed ledger with growing lists of records (blocks) that are securely linked together via cryptographic hashes. In some embodiments, the audit module 320 may verify or authenticate and protect completed compliance templates using a digital signature, a blockchain system, encryption, and/or the like (e.g., prior to sending the completed template to an accreditation organization).

In certain embodiments, the compliance tasks are searchable using tags, keywords, artificial intelligence (e.g., generative AI), or the like so that administrators or other users can locate, find, and review compliance templates, compliance tasks, and/or check the status of the compliance templates/tasks. The user may further search and filter the compliance templates by building, user, compliance task, equipment, asset, and/or any combination of the foregoing. The user may further filter the compliance tasks by tasks that are overdue, tasks that need to be done now, tasks that need to be done in the next week, month, year, etc., and/or the like so that the user can get a snapshot of the compliance status of the organization. A daily/weekly/monthly summary report may further be created to give an administrator, supervisor, manager, or the like a daily status of their compliance tasks.

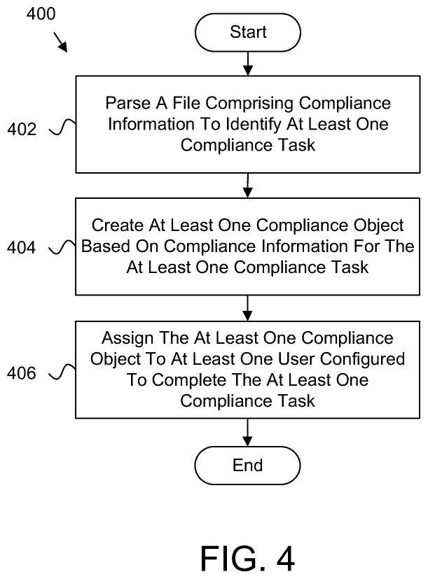

FIG. 4 illustrates a schematic flow-chart diagram of one embodiment of a method 400 for a task management system. In one embodiment, the method 400 begins and parses 402 a file comprising compliance information to identify at least one compliance task. In further embodiments, the method 400 creates 404 at least one compliance object based on compliance information for the at least one compliance task. In some embodiments, the method 400 assigns 406 the at least one compliance object to at least one user configured to complete the at least one compliance task, and the method 400 ends. In certain embodiments, the parse module 202, the compliance object module 204, and/or the user module 206 perform the various steps of the method 400.

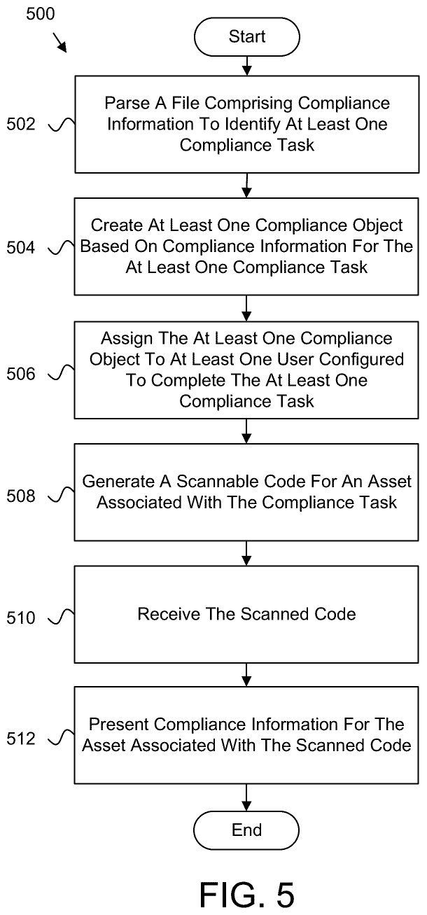

FIG. 5 illustrates a schematic flow-chart diagram of one embodiment of a method 500 for a task management system. In one embodiment, the method 500 begins and parses 502 a file comprising compliance information to identify at least one compliance task. In further embodiments, the method 500 creates 504 at least one compliance object based on compliance information for the at least one compliance task. In some embodiments, the method 500 assigns 506 the at least one compliance object to at least one user configured to complete the at least one compliance task.

In some embodiments, the method 500 generates 508 a scannable code for an asset associated with the compliance task. In one embodiment, the method 500 receives the scanned code, e.g., from a user's device. In one embodiment, the method 500 presents 512 compliance information for the asset associated with the scanned code, and the method 500 ends. In certain embodiments, the parse module 202, the compliance object module 204, the user module 206, the asset module 304, and/or the presentation module 312 perform the various steps of the method 500.

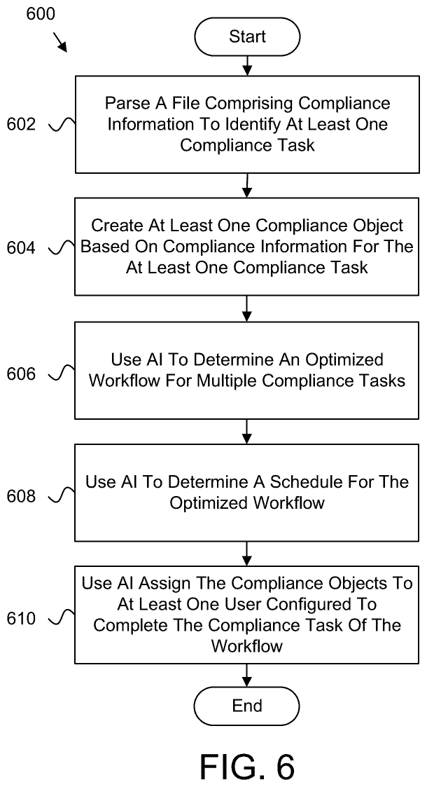

FIG. 6 illustrates a schematic flow-chart diagram of one embodiment of a method 600 for a task management system. In one embodiment, the method 600 begins and parses 602 a file comprising compliance information to identify at least one compliance task. In further embodiments, the method 600 creates 604 at least one compliance object based on compliance information for the at least one compliance task.

In some embodiments, the method 600 uses 606 AI to determine an optimized workflow for completing multiple compliance tasks. In one embodiment, the method 600 uses 608 AI to determine a schedule for completing the compliance tasks of the workflow. In some embodiments, the method 600 uses 610 AI to assign the compliance objects for the compliance tasks of the workflow to at least one user, and the method 600 ends. In certain embodiments, the parse module 202, the compliance object module 204, the user module 206, the asset module 304, artificial intelligence module 306, the scheduling module 308, and/or the workload module 310 perform the various steps of the method 600.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
at least one memory; and
at least one processor that is coupled to the memory and is configured to cause the apparatus to:
parse a file comprising compliance information to identify at least one compliance task;
create at least one compliance object based on compliance information for the at least one compliance task; and
assign the at least one compliance object to at least one user configured to complete the at least one compliance task.

2. The apparatus of claim 1, wherein the at least one compliance task is associated with a location.

3. The apparatus of claim 2, wherein the location comprises at least one of a building, a floor, or a room.

4. The apparatus of claim 2, wherein the at least one compliance task is associated with an asset at the location.

5. The apparatus of claim 4, wherein the at least one processor is configured to cause the apparatus to generate a unique code for the asset.

6. The apparatus of claim 5, wherein the unique code comprises a scannable code that comprises a link to the at least one compliance object comprising information for the at least one compliance task associated with the asset.

7. The apparatus of claim 4, wherein the at least one processor is configured to cause the apparatus to process an image of the location using an artificial intelligence engine to identify at least one asset at the location and provide compliance information for the at least one asset from the at least one compliance object associated with the at least one asset.

8. The apparatus of claim 1, wherein the at least one processor is configured to cause the apparatus to generate a compliance schedule for the at least one compliance task.

9. The apparatus of claim 8, wherein the at least one processor is configured to cause the apparatus to notify the user assigned to complete the at least one compliance task at least once prior to a completion deadline for the at least one compliance task based on the compliance schedule.

10. The apparatus of claim 8, wherein the at least one processor is configured to cause the apparatus to generate a workflow for completing the at least one compliance task based on the compliance schedule.

11. The apparatus of claim 10, wherein the at least one processor is configured to cause the apparatus to optimize the workflow based on dependencies between the at least one compliance task.

12. The apparatus of claim 10, wherein the at least one processor is configured to cause the apparatus to provide the workflow to an artificial intelligence engine for optimization.

13. The apparatus of claim 1, wherein the at least one processor is configured to cause the apparatus to present the compliance information for the at least one compliance task for the at least one compliance object on a graphical interface.

14. The apparatus of claim 13, wherein the at least one processor is configured to cause the apparatus to visually highlight the at least one compliance task based on state of the at least one compliance task.

15. The apparatus of claim 1, wherein the at least one processor is configured to cause the apparatus to provide a generative artificial intelligence interface for receiving prompts related to the at least one compliance task.

16. A method, comprising:
parsing a file comprising compliance information to identify at least one compliance task;
creating at least one compliance object based on compliance information for the at least one compliance task; and
assigning the at least one compliance object to at least one user configured to complete the at least one compliance task.

17. The method of claim 16, wherein the at least one compliance task is associated with a location.

18. The method of claim 17, wherein the location comprises at least one of a building, a floor, or a room.

19. The method of claim 17, wherein the at least one compliance task is associated with an asset at the location.

20. A program product comprising a non-transitory computer readable storage medium that stores code executable by a processor, the executable code comprising code for:
parsing a file comprising compliance information to identify at least one compliance task;
creating at least one compliance object based on compliance information for the at least one compliance task; and
assigning the at least one compliance object to at least one user configured to complete the at least one compliance task.
